(19) United States
(12) Patent Application Publication
(10) Pub. No.: US 2008/0281745 A1
(43) Pub. Date: Nov. 13, 2008

(54) System And Method For Requesting A Support Service From An Electronic Trading System

(76) Inventor: James C. Johnson, Cresskill, NJ (US)

Correspondence Address: BAKER BOTTS L.L.P., 2001 ROSS AVENUE, SUITE 600, DALLAS, TX, 75201-2980, US

(21) Appl. No.: 11/745,774

(22) Filed: May 8, 2007

(51) Int. Cl. G06Q 40/00

(52) U.S. Cl. 705/37

(57) ABSTRACT

A system for providing a support service includes a memory and one or more processors. The memory stores context information associated with a trader of a trading system. The processors provide a button that when selected initiates the communication of a support service request requesting a support service for the trader. The processors receive the support service request. A communication session with a support entity is established in order to provide the support service to a client system of the trader, where the communication session allows the support entity to communicate with the client system. The processors send the context information to the support entity.

### TECHNICAL FIELD

This invention relates generally to the field of electronic trading and more specifically to a system and method for requesting a support service from an electronic trading system.

### BACKGROUND

In recent years, electronic trading systems have gained widespread acceptance for trading a wide variety of items, such as goods, services, financial instruments, and commodities. For example, electronic trading systems may be used to trade stocks, fixed income securities, currencies, futures contracts, oil, and gold.

A trader may submit trading orders to a trading system in order to initiate trades. The trading system may process the trading orders to determine whether the orders can be satisfied. At some point, the trader may want to request help in conjunction with performing a transaction. Known techniques for requesting help, however, are not efficient in certain situations.

### SUMMARY OF THE DISCLOSURE

In accordance with the present invention, disadvantages and problems associated with previous techniques for providing a support service may be reduced or eliminated.

According to one embodiment, a system for providing a support service includes a memory and one or more processors. The memory stores context information associated with a trader of a trading system. The processors provide a button that when selected initiates the communication of a support service request requesting a support service for the trader. The support service request is received. A communication session with a support entity is established in order to provide the support service to a client system of the trader. The communication session allows the support entity to communicate with the client system. The processors send the context information to the support entity.

Certain embodiments of the invention may provide one or more technical advantages. A technical advantage of one embodiment may be that a support service manager may automatically manage a request for a support service. In the embodiment, the support service manager may allow a trader to submit a support service request to request a support service. The support service manager may then readily provide the support service in response to the request, thus aiding the trader in a relatively short period of time.

Another technical advantage of one embodiment may be that the support service manager may have a support entity, such as a help desk, provide the support service. The support entity may communicate with the client system either through the support service manager or directly with the client system. Thus, the support service manager can readily place the trader in contact with the support entity.

Another technical advantage of one embodiment may be that the support service manager may use rules to provide the support service. Thus, the support service manager may quickly provide the support service to the trader independently of a support entity.

Another technical advantage of one embodiment may be that the support service manager may provide a graphical user interface (GUI) that the trader may use to submit the support service request to request the support service. The GUI may include buttons that the trader can select to describe the requested service.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a trading system in which a support service is provided to a trader according to the present invention;

FIG. 2 illustrates one embodiment of a template of a graphical user interface (GUI) that may be used with the system of FIG. 1; and

FIG. 3 illustrates one embodiment of a method for providing a support service to a trader.

### DETAILED DESCRIPTION OF THE DRAWINGS

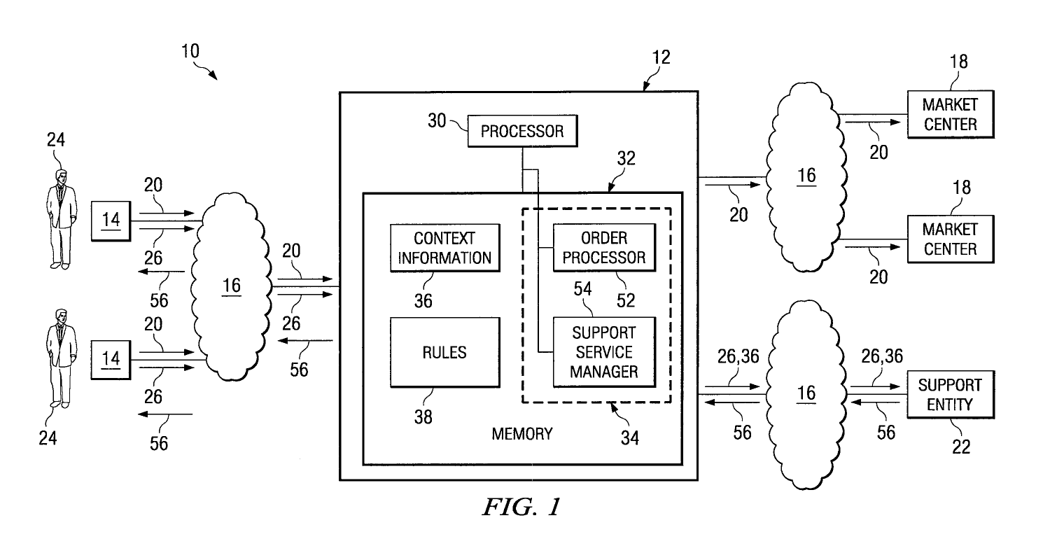

Embodiments of the present invention and its advantages are best understood by referring to FIGS. 1 through 3 of the drawings, like numerals being used for like and corresponding parts of the various drawings.

FIG. 1 illustrates one embodiment of a trading system 10 operable to receive and execute trading orders 20 from traders 24. According to the embodiment, a trading platform 12 is coupled to one or more client systems 14, one or more market centers 18, and a support entity 22 via one or more networks 16. Trading platform 12 includes a processor 30 and a memory 32. Memory 32 stores context information 36, rules 38, an order processor 52, and a support service manager 54.

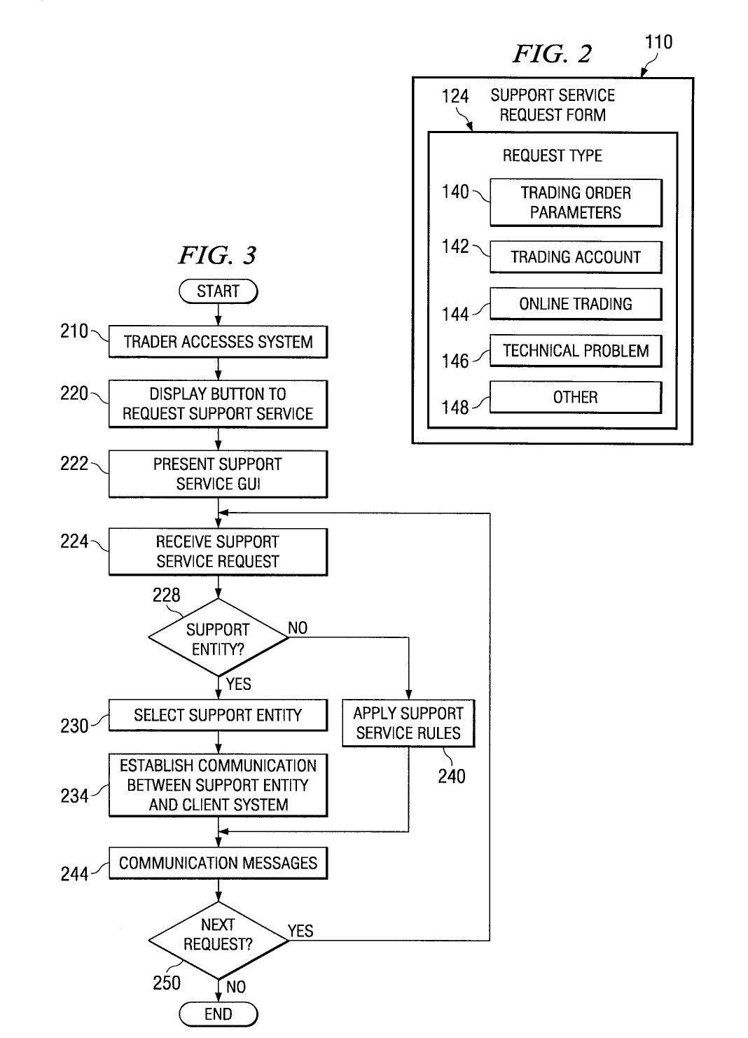

In one example, trader 24 may encounter a technical problem in conjunction with performing some aspect of a transaction in system 10. For example, trader 24 may not be able to submit a trading order 20. Client system 14 provides an opportunity for trader 24 to initiate a support service session with platform 12. For example, trader 24 may communicate a support service request 26 to platform 12 using one or more inputs associated with a graphical user interface (GUI), a template of which is described in more detail with reference to FIG. 2. In a particular embodiment, the trader 24 can activate a “help button” to bring up the GUI used to communicate a request 26. The GUI and associated “help button” may be provided by support service manager 54 of platform 12.

Support service manager 54 may provide the support service in response to the support service request 26. In one example, support service manager 54 may have support entity 22 provide the support service. Support entity 22 may communicate with client system 14 either through support service manager 54 or directly with client system 14. In another example, support service manager 54 may use rules 38 to provide the support service independently of any support entity 22. The support service may provide a support service response 56 that includes, for example, a response to questions posed by trader 24 or commands that may resolve technical problems at client system 14. Additional details regarding the support service are described below.

According to one embodiment, traders 24 may represent users of trading system 10 capable of placing and/or responding to trading orders 20. A trader 24 may represent a principal, an agent acting on behalf of a principal, an individual, a legal entity (such as a corporation), or any machine or mechanism that is capable of placing and/or responding to trading orders 20.

A trading order 20 may represent an order to buy or sell a particular amount of a particular trading product. A trading product may refer to any suitable product or combination of products that forms the basis of a given trading order 20. Examples of trading products may include any type of goods, services, financial instruments, commodities, equities, stocks, fixed income securities, interest rate derivatives, currencies, futures contracts, debentures, options, securities, derivative trading instruments, or any other suitable product or combination of products.

A trading order 20 may include trading order parameters that specify particular values for variables of trading order 20. Examples of trading order parameters may include a quantity of a trading product, a type of trading product, a target price, other parameters describing a trading order 20, or any combination of the preceding. A target price may refer to a target bid price and/or target offer price.

A client system 14 may represent any suitable end-user element that may be used by traders 24 to access one or more elements of trading system 10, such as trading platform 12. Examples of an end-user element include a computer, a workstation, a telephone, an Internet browser, an electronic notebook, a personal digital assistant (PDA), a pager, or any other suitable device (wireless or otherwise) capable of receiving, processing, storing, and/or communicating information with other components of system 10.

A network 16 may represent a communication platform operable to exchange information. A communication network may comprise at least a portion of a plain old telephone system (POTS), a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding.

Trading platform 12 may represent a trading architecture that facilitates the processing of trading orders 20. Trading platform 12 may be configured at a management center or a headquartering office for any person, business, or entity that seeks to manage the trading of orders 20. Trading platform 12 may include any suitable combination of logic, personnel, devices, or entities that may be utilized to perform the operations of an administrative body or a supervising entity that manages or administers a trading environment.

According to the illustrated embodiment, trading platform 12 may comprise a processor 30 and a memory 32 coupled as shown. Processor 30 may comprise hardware and/or software and may execute instructions of applications 34 and manipulate data of memory 32.

Memory 32 may comprise hardware and/or software, and may store applications 34, one or more rules 38, and context information 36. Applications 34 may include an order processor 52 and support service manager 54. Order processor 52 may process trading orders 20 to determine whether trading orders 20 can be satisfied and the order in which trading orders 20 can be satisfied. A trading order 20 may be satisfied in any suitable manner. As an example, a buy order requesting a specific trading amount at a bid price may be satisfied by a sell order that is able to provide the trading amount (or more) at the bid price (or less). As another example, a sell order offering a specific trading amount at an offer price may be satisfied by a buy order that is requesting the specific trading amount (or less) at the offer price (or more).

Support service manager 54 manages support services for traders 24. A support service may provide, for example, responses to questions posed by trader 24 or commands that may resolve technical problems at client system 14. As an example, a trader 24 may have questions about trading orders 20, trading accounts, and/or online trading, or may have technical problems. A support service may provide responses to the questions or commands to resolve the problems.

According to one embodiment, support service manager 54 may display on client system 14 a button that trader 24 may select to submit support service request 26 to request a support service. The button may be a graphical element of any suitable size or shape, a menu item, a keystroke, or other suitable screen element. According to one embodiment, selecting the button may initiate generation of a graphical user interface (GUI) at client system 14 that may be used to submit support service request 26.

Support service manager 54 provides a support service in response to support service request 26. According to one embodiment, support service manager 54 may provide a support service using support entity 22. Support service manager 54 may select a support entity 22 appropriate to respond to support service request 26. For example, support service manager 54 may select a support entity 22 comprising a representative of the management office of trading platform 12 to respond to questions about trading orders 20 or trading accounts. Support service manager 54 may select a support entity comprising a trading expert to respond to questions about online trading, or may select a support entity 22 comprising an information technology (IT) service person to respond to a technical problem.

Support service manager 54 may establish communication between support entity 22 and client system 14 to provide the support service. In one example, support service manager 54 may communicate messages (such as electronic mail, instant messaging, voice packet, and/or text messages) between support entity 22 and client system 14. In another example, support service manager 54 may establish a communication session between support entity 22 and client system 14. Support entity 22 and client system 14 may then communicate messages between each other independent of support service manager 54 by using the communication session. According to another embodiment, support service manager 54 may provide the support service using one or more support service rules 38 as described below.

According to one embodiment, the support service may be provided to client system 14 within any suitable specified period of time after trader 24 has sent a request, for example, less than one hour, less than 30 minutes, less than 20 minutes, less than 15 minutes, less than 10 minutes, less than 5 minutes, or less than 1 minute. That is, the support service may be regarded as automatic.

Memory 32 may store context information 36 and one or more rules 38. Context information 36 may include any suitable type of information that may be used to provide a support service, for example, information about support service request 26, trader 14, client system 14, trading order 20, and/or the network elements of system 10. Examples of context information 36 include a current desktop configuration of client system 14, a screen shot at client system 14, a log file of actions performed at client system 14, a list of actions performed on a trading account, and a network management system report of technical problems experienced by trading system 12 or other components in communication with trading system 12.

Rules 38 may comprise support service rules for providing support services. In one example, a rule 38 may specify that if a request for information is received, then a particular data file that includes the information should be sent to client system 14. For example, if a question about a trading order 20, trading account, or online trading is received, then information about the trading order 20, trading account, or online trading is sent to client system 14.

In another example, a rule 38 may specify that if a problem is reported, then certain commands should be sent to client system 14 to address the problem. For example, if a technical problem is reported, then commands that address the technical problem should be sent to client system 14.

In another example, a rule 38 may specify that if a particular type of request is received, then a specific support entity 22 should be selected. For example, if a request about a trading order 20, trading account, online trading, or technical problem is received, then support entity 22 for the trading order 20, trading account, online trading, or technical problem, respectively, should be selected. For example, support service manager 54 may select a support entity 22 comprising a representative of the management office of trading platform 12 to respond to questions about trading orders 20 or trading accounts. Support service manager 54 may select a support entity comprising a trading expert to respond to questions about online trading, or may select a support entity 22 comprising an information technology (IT) service person to respond to a technical problem.

Market centers 18 comprise all manner of order execution venues including exchanges, Electronic Communication Networks (ECNs), Alternative Trading Systems (ATSs), market makers, or any other suitable market participants. Each market center 18 may maintain a bid and offer price for a given trading product by standing ready, willing, and able to buy or sell that trading product at publicly quoted prices, also referred to as market center prices. Different market centers 18 may provide different market center prices for particular trading products. For example, a particular market center 18 may offer a particular bid price and/or offer price for a particular trading product, while another market center 18 may offer a different bid price and/or offer price for the same trading product. A particular market center 18 may charge a transaction cost to execute trading orders 20 that remain in the order books of that market center 18 for more than a certain length of time.

Support entity 22 may represent any suitable entity operable to provide a support service to trader 24 in cooperation with or independent of service support manager 54. Examples of support entity 22 include a help desk with a trading platform 12 representative, a trading expert, or an information technology (IT) service.

Support entity 22 may include any suitable combination of logic, personnel, devices, or other entities that may be utilized to provide the support service. In one embodiment, support entity 22 may include personnel that can provide responses to requests 26. In the embodiment, the personnel may be able to provide the support services by accessing a database that includes information for responding to requests 26. In another embodiment, support entity 22 may include a database that may automatically provide responses by sending data files.

Modifications, additions, or omissions may be made to trading system 10 without departing from the scope of the invention. The components of trading system 10 may be integrated or separated according to particular needs. Moreover, the operations of system 10 may be performed by more, fewer, or other modules.

FIG. 2 illustrates one embodiment of a graphical user interface (GUI) template 110 that may be used to submit a support service request 26. GUI template 110 may include any suitable information and may have any suitable format. According to the illustrated embodiment, GUI template 110 includes a request type section 124.

Request type section 124 includes buttons that may be selected to request a particular type of support service. Selection of a particular button may bring up additional screens with additional buttons. The selections made by trader 24 may allow support service managers 54 to route the support service request to the appropriate support entity 22 or to identify the appropriate rules 38 to apply.

According to the illustrated embodiment, request type section 124 has buttons that address particular trading issues, for example, trading order, trading account, online trading, and/or technical problem issues. According to the illustrated embodiment, request type section 124 includes a “trading order” button 140, a “trading account” button 142, an “online trading” button 144, a “technical problem” button 146, and an “other” button 148.

“Trading order” button 140 may be used to submit a request for a trading order support service, which may involve responding to questions about or problems with trading orders 20. Trading order questions may include questions about submitting a trading order 20 or about trading orders 20 that have been executed. Examples of questions about submitting a trading order 20 may include questions about completing an online form to submit trading order 20, terms or phrases included in the online form, and/or the steps required to submit the online form. Examples of questions about an executed trading order 20 may include questions about terms or phrases included in the response and/or steps to dispute the response. Problems with a trading order 20 may include, for example, problems with submitting trading order 20, with processing trading order 20, and/or with the response to trading order 20.

“Trading account” button 142 may be used to submit a request for a trading account support service, which may involve responding to questions about or problems with trading accounts. Trading account questions may include, for example, questions about setting up a trading account and/or questions about existing trading accounts. Examples of questions about setting up a trading account may include questions about the costs and/or fees associated with a trading account, activating the trading account, qualifying for the trading account, and/or other questions about setting up an account. Examples of questions about an existing trading account may include questions about selecting or changing the settings for the trading account, identifying the existing settings, and/or disputing the settings.

“Online trading” button 144 may be used to submit a request for an online trading support service, which may involve responding to questions about online trading or about placing a trade. Examples of online trading questions may include questions about trading terms, trading strategies, and/or market data.

“Technical problem” button 146 may be used to indicate that a technical problem was encountered. Examples of technical problems include a problem with sending a trading order 20, with receiving the results of processing the trading order 20, with completing a trading order form, or other problem. If technical problems button 146 is selected, a list of common technical problems from which trader 24 may select may be presented. The list may include an “other” option in which trader 24 may provide a description of the technical problem.

“Other” button 148 may be used for support services that are not listed in request type section 124. If other request button 148 is selected, a window in which trader 24 may describe the request may be presented.

Modifications, additions, or omissions may be made to GUI template 110 without departing from the scope of the invention. GUI template 110 may include more, fewer, or other fields or values. Additionally, fields or values may be arranged in any suitable manner without departing from the scope of the invention.

FIG. 3 illustrates one embodiment of a method for providing a support service. The method begins at step 210, where trader 24 accesses trading system 10.

A button to request a support service is displayed at step 220. The button may be displayed on any suitable screen on the interface of client system 14. Support service GUI from template 110 may be presented at step 222 in response to trader 24 selecting the button. In some embodiments, the support service GUI from template 110 is presented regardless of whether any other buttons are previously selected by trader 24. GUI template 110 may allow trader 24 to submit a support service request 26.

Support service request 26 is received from trader 24 at step 224. Request 26 includes information about the type of support service being sought, as described above. Support service manager 54 responds to support service request 26 at steps 234 through 244. Support service manager 54 may have support entity 22 provide the support service at step 228. If a support entity 22 is to be used, the method proceeds to step 230, where support service manager 54 selects a support entity 22 appropriate for providing the support service. The support entity 22 may be selected according to the type of support service requested. For example, a support entity 22 that can provide technical support may be used to provide the support service for a technical problem.

Communication between support entity 22 and client system 14 is established at 234. In one example, support service manager 54 may communicate messages (such as electronic mail, instant messaging, voice packet, and/or text messages) between client system 14 and support entity 22. In another example, support service manager 54 may set up a communication session through which client system 14 and support entity 22 may communicate independently of support service manager 54. The method then proceeds to step 244.

If a support entity is not used at step 228, the method proceeds to step 240, where support service manager 54 applies rules 38 to provide the support service. The method then proceeds to step 244.

Messages are communicated at step 244 in order to provide the service. The messages may include a support service response 56 that has information responding to questions posed by authorized trader 24 or commands that address problems reported by trader 24.

A next support service request 26 may be received at step 250. If a next support service request 26 is received, the method returns to step 224 where the next support service request is received. If there is no next support service request, the method terminates.

Modifications, additions, or omissions may be made to the method without departing from the scope of the invention. The method may include more, fewer, or other steps. Additionally, steps may be performed in any suitable order without departing from the scope of the invention.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A system for providing a support service, comprising:
a memory operable to:
store context information associated with a trader of a trading system; and
one or more processors in communication with the memory and operable to:
provide a button that when selected initiates the communication of a support service request, the support service request requesting a support service for the trader;
receive the support service request;
establish a communication session with a support entity in order to provide the support service to a client system of the trader, the communication session allowing the support entity to communicate with the client system; and
send the context information to the support entity.

2. The system of claim 1, wherein the support service addresses at least one of the following:
a trading order issue;
a trading account issue;
an online trading issue; and
a technical problem.

3. The system of claim 1, wherein:
the support service request includes a question from the trader; and
the support service provides a response to the question.

4. The system of claim 1, wherein:
the support service request describes a technical problem faced by the client system; and
the support service provides one or more commands to address the technical problem.

5. The system of claim 1, wherein the one or more processors are further operable to:
apply one or more support service rules to the context information to provide the support service.

6. The system of claim 1, wherein the support service comprises communicating at least one of the following:
a command message;
a electronic mail message;
an instant messaging message;
a voice packet message; and
a text message.

7. A method for providing a support service, comprising:
storing context information associated with a trader of a trading system;
providing a button that when selected initiates the communication of a support service request, the support service request requesting a support service for the trader;
receiving the support service request;
establishing a communication session with a support entity in order to provide the support service to a client system of the trader, the communication session allowing the support entity to communicate with the client system; and
sending the context information to the support entity.

8. The method of claim 7, wherein the support service addresses at least one of the following:
a trading order issue;
a trading account issue;
an online trading issue; and
a technical problem.

9. The method of claim 7, wherein:
the support service request includes a question from the trader; and
the support service provides a response to the question.

10. The method of claim 7, wherein:
the support service request describes a technical problem faced by the client system; and
the support service provides one or more commands to address the technical problem.

11. The method of claim 7, further comprising:
applying one or more support service rules to the context information to provide the support service.

12. The method of claim 7, wherein the support service comprises communicating at least one of the following:
a command message;
a electronic mail message;
an instant messaging message;
a voice packet message; and
a text message.

13. A system for providing a support service, comprising:
a support entity operable to provide a support service to a trader of a trading system; and
a trading platform operable to:
store context information associated with the trader;
provide a button that when selected initiates the communication of a support service request, the support service request requesting the support service for the trader;
receive the support service request;
establish a communication session with the support entity in order to provide the support service to a client system of the trader, the communication session allowing the support entity to communicate with the client system; and
send the context information to the support entity.

14. The system of claim 13, wherein the support service addresses at least one of the following:
a trading order issue;
a trading account issue;
an online trading issue; and
a technical problem.

15. The system of claim 13, wherein:
the support service request includes a question from the trader; and
the support entity is further operable to provide the support service by communicating a response to the question.

16. The system of claim 13, wherein:
the support service request describes a technical problem faced by the client system; and
the support entity is further operable to provide the support service by communicating one or more commands to address the technical problem.

17. The system of claim 13, wherein the trading platform is further operable to:
apply one or more support service rules to the context information to provide the support service.

18. The system of claim 13, wherein the support entity is further operable to provide the support service by communicating at least one of the following:
a command message;
a electronic mail message;
an instant messaging message;
a voice packet message; and
a text message.

19. The system of claim 13, wherein the trading platform is further operable to:
select the support service in accordance with the support service request.

20. The system of claim 13, wherein the support entity is associated with at least one of the following:
a representative of the trading platform;
a trading expert; and
an information technology (IT) service.
